(19) United States
(12) Patent Application Publication
(10) Pub. No.: US 2006/0195694 A1
(43) Pub. Date: Aug. 31, 2006

(54) Method and apparatus for authenticated dial-up access to command controllable equipment

(76) Inventor: William G. O'Brien, Orleans (CA)

Correspondence Address: FETHERSTONHAUGH - SMART & BIGGAR, 1000 DE LA GAUCHETIERE WEST, SUITE 3300, MONTREAL, QC, H3B 4W5, CA

(21) Appl. No.: 11/315,010

(22) Filed: Dec. 23, 2005

Related U.S. Application Data
(63) Continuation of application No. 09/760,861, filed on Jan. 16, 2001, now abandoned.

(51) Int. Cl. H04L 9/00

(52) U.S. Cl. 713/168

(57) ABSTRACT

A method and apparatus for secure and authenticated access to command controllable computerized equipment is described. The method involves using an access apparatus that prevents access to the command controllable computerized equipment until a user is authenticated as a trusted user authorized to access the command controllable computer equipment. The apparatus may be a secure access controller or a secure access transceiver. Each has a normally disabled data port that prevents the pass-through of data until a user is authenticated as a trusted user. The apparatus may operate under autonomous control or under the control of a network centric control facility. The advantage is secure control of access to command controllable computerized equipment that enables remote access to the equipment by authorized users with substantially no risk of compromise.

The present invention is a continuation of prior U.S. patent application Ser. No. 09/760,861 to William G. O'Brien, filed on Jan. 16, 2001, hereby incorporated by reference herein.

### TECHNICAL FIELD

The present invention relates generally to security and the control of access to equipment through a dial-up connection and, in particular, to methods and apparatus for controlling access to command controllable computerized equipment accessed through a transceiver connected to a dial-up line.

### BACKGROUND OF THE INVENTION

Decentralization of service provision is a rapidly developing trend in the service industry. Two simple examples of services provided in a decentralized manner are: the remote maintenance of computerized equipment and access to dial-up services such as banking services. This trend is fuelled by the continuing miniaturization of computing equipment, the exponential increase in processing power of computing equipment and the convenience of providing services at a customer's premises. However, there is a cost associated with the convenience afforded by providing decentralized services. Access to computerized equipment is frequently accomplished using a dial-up connection to a transceiver, such as a modem. This arrangement enables maintenance of the computerized equipment without the expense of dispatching a maintenance person to the site. The enablement of such access, however, exposes the computerized equipment to attacks from unauthorized persons who accidentally or illegally obtain the dial-up address of the transceiver. Such vulnerability is of significant concern to service providers and has curtailed the development and deployment of decentralized service offerings. There therefore exists a need for a transceiver that enables control over access to computerized equipment that may be accessed through a dial-up connection.

Another attempted solution to the problem is described in the U.S. Pat. No. 5,724,426 to Rosenow et al., which issued on Mar. 3, 1998. Rosenow discloses means for controlling access to computer system resources which enable each new session to employ different encryption keys derived from multiple random numbers and multiple hidden algorithms without transmitting the keys across a communication line. Although this system also has merit, it does not provide an optimal solution for the need to enforce control over access to remote computerized equipment because it assumes a central access control system that employs a dedicated parallel control network, such as a LAN, to centrally manage access control tables of an access-controlled system of resources.

There therefore exists a need for a method and apparatus enabling control over secure access to command controllable computerized equipment. The method and apparatus preferably provide user authentication, access control and optimal transaction records.

### OBJECTS OF THE INVENTION

It is an object of the invention to provide secure access to computerized equipment by a remote entity.

It is another object of the invention to provide enforcement of network-centric control of authenticated access to command controllable computerized equipment.

It is another object of the invention to provide an authentication process in which a user connecting to a secure access transceiver is authenticated as part of a handshake sequence.

It is another object of the invention to provide network-centric distribution of authentication information consisting of electronic access keys.

It is another object of the invention to provide an authentication server for controlling access to computerized equipment by a remote entity.

It is another object of the invention to provide a secure access controller enabled to authenticate a caller, the access controller being positioned between a modem and computerized equipment to be accessed through a dial-up connection.

It is another object of the invention to provide a secure access controller connected to command controllable computerized equipment, the secure access controller being enabled to permit data to pass through the secure access controller upon establishing an authenticity of a service point and to prevent data from passing through the secure access controller otherwise.

### SUMMARY OF THE INVENTION

According to one aspect of the invention, a system is provided for controlling access to computerized equipment by a remote entity. The system includes an authentication server and an access controller interconnectable with each other and with the remote entity for communications therebetween, where the access controller is connected to the computerized equipment. The authentication server is operable to provide the remote entity with a first access key and the access controller with a second access key corresponding to the first access key. The access controller is operable to attempt to authenticate the remote entity at least in part on a basis of the access keys, wherein the access controller enables data to pass from the remote entity to the computerized equipment only upon successful authentication of the remote entity.

According to another aspect of the invention, a method is provided for controlling access to computerized equipment by a remote entity, the computerized equipment being connected to an access controller operative to enable data to be passed from the remote entity to the computerized equipment if the remote entity is successfully authenticated. The method includes the steps of receiving a request for access to the computerized equipment from the remote entity, determining a first access key and a second access key corresponding to the first access key, providing the first access key to the remote entity and providing the second access key to the access controller for use in the authentication of the remote entity.

According to yet another aspect of the invention, an authentication server is provided for controlling access to computerized equipment by a remote entity, where the computerized equipment is connected to an access controller. The authentication server is responsive to a request from the remote entity for access to the computerized equipment to provide the remote entity with a first access key and the access controller with a second access key corresponding to the first access key. The first access key is usable by the remote entity for communication with the access controller and the second access key is usable by the access controller for attempting to authenticate the remote entity. The access controller enables data to be passed from the remote entity to the computerized equipment only upon successful authentication of the remote entity.

According to a further aspect of the invention, there is provided, in an authentication server, a method of controlling access to computerized equipment by a remote entity, where the computerized equipment is connected to an access controller operative to enable data to be passed from the remote entity to the computerized equipment if the remote entity is successfully authenticated. The method includes the steps of receiving a request from the remote entity for access to the computerized equipment, delivering a first access key to the remote entity for use in communicating with the access controller, and delivering a second access key to the access controller for use in the authentication of the remote entity.

According to another aspect of the invention, an access controller is provided for intermediating communications between a remote entity and computerized equipment, the remote entity using a first access key for communicating with the access controller. The access controller is operative to use a second access key complementary to the first access key for attempting to authenticate the remote entity. The access controller enables data to be passed from the remote entity to the computerized equipment only upon successful authentication of the remote entity.

According to yet another aspect of the invention, there is provided, in an access controller, a method for selectively passing data from a remote entity to computerized equipment in order to ensure secure access to the computerized equipment, where the remote entity uses a first access key for communicating with the access controller. The method includes using a second access key complementary to the first access key for attempting to authenticate the remote entity. If authentication of the remote entity is successful, the method includes enabling data to be passed from the remote entity to the computerized equipment. If authentication of the remote entity fails, the method includes preventing data from being passed from the remote entity to the computerized equipment.

### BRIEF DESCRIPTION OF THE DRAWINGS

The invention will now be described by way of example only, and with reference to the accompanying drawings, in which:

FIG. 1 is a connection diagram showing a secure access transceiver with an integrated secure access controller providing authentication checks and enabling access to an access port of a telecommunications switch;

FIG. 2 is a connection diagram showing a transceiver connected to a secure access controller which provides authentication and access to a telecommunications switch;

FIG. 3 is a schematic diagram showing the relationships between a service point, equipped with a secure service transceiver, a service co-ordination center and secure access transceivers connected to command controllable computing equipment such as a telecommunications switch;

FIG. 4 is a schematic diagram showing the relationships between a stand alone user equipped with a secure service transceiver and an authentication server;

FIG. 5 is a schematic diagram showing the relationships between users associated with a service center includes a pool of secure service transceivers; and an authentication server;

FIG. 6 is a schematic diagram showing the relationships between a service point equipped with a service transceivers, a co-ordination center, access transceivers and secure access controllers connected to command controllable computing equipment such as a telecommunications switch;

FIG. 7 is a schematic diagram showing the relationships between a stand-alone user equipped with a service transceivers and an authentication server;

FIG. 8 is a schematic diagram showing the relationships between users associated with a service center having a pool of service transceivers, and an authentication server;

FIG. 9 is a flow diagram showing the details of a handshake sequence ending in authentication of a remote service point as implemented on secure transceivers;

FIG. 10 is a flow diagram showing a process by which a secure access transceiver validates a remote calling transceiver;

FIG. 11 is a flow diagram showing a process by which a remote calling transceiver validates the secure access transceiver;

FIG. 12 is a flow diagram showing the initiation of a service call from a workstation associated with a service center equipped with a pool of secure service transceivers;

FIG. 13 is a flow diagram showing the details of a link establishing process in which a secure access controller authenticates a remote service point;

FIG. 14 is a flow diagram showing a process by which a secure access controller validates a calling entity;

FIG. 15 is a flow diagram showing a process by which a valid link is established between a remote point and secure access controller after the remote point validates the secure access controller;

FIG. 16 is a flow diagram showing the details of the initiation of a service call from a workstation associated with a service center equipped with a pool of service transceivers in order to connect to a secure access controller through an access transceiver;

FIG. 17 is a flow diagram showing a process by which a service access request is initiated;

FIG. 18 is a flow diagram showing a process by which a secure access equipment is updated with new access keys;

FIG. 19 is a flow diagram showing a process for placing a service call to establish a service session with command controllable computerized equipment, and

FIG. 20 is a flow diagram showing a process by which a control point and secure access equipment activate administration mode.

### DETAILED DESCRIPTION OF THE PREFERRED EMBODIMENT

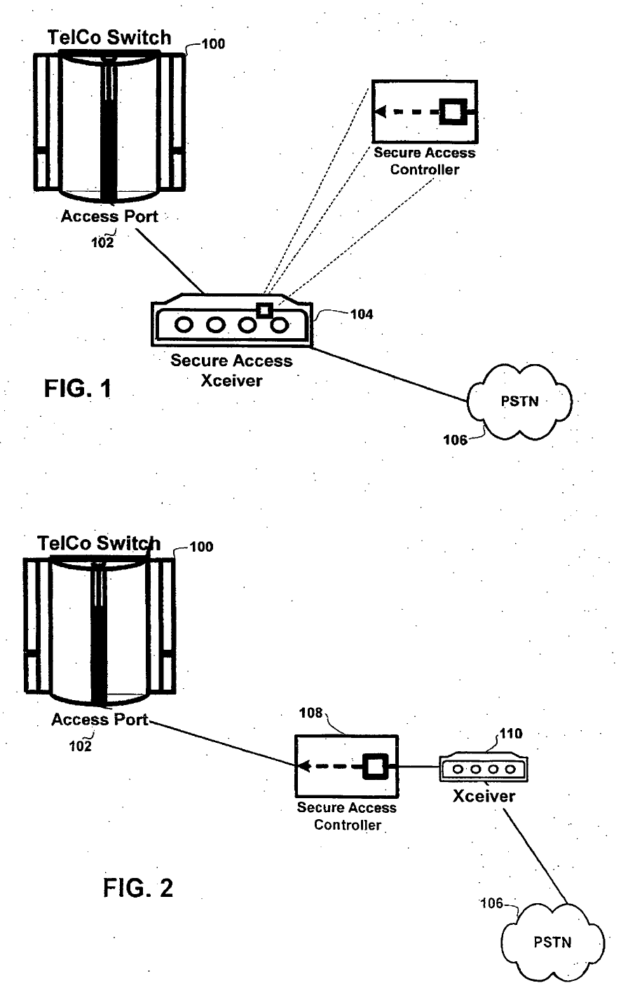

In accordance with a first embodiment of the invention, there is provided a secure access transceiver for secure authenticated access to computerized equipment. The secure access transceiver performs all the functions of a standard modem if a remote user successfully authenticates as a trusted authorized user having access to the computerized equipment. Otherwise, a communications port of the transceiver connected to the computer equipment is disabled to ensure that access to the equipment is unconditionally denied. This preferred implementation is shown in FIG. 1 in which a telecommunications switch 100 having at least an access port 102 is connected to the secure access transceiver 104. The secure access transceiver 104 has an integrated secure access controller. According to this implementation, the telecommunications switch 100 is accessed for systems maintenance from the public switched telephone network 106 through the secure access transceiver 104.

In accordance with a second embodiment of the invention, access to the computerized equipment is controlled by a secure access controller connected to a link between a transceiver and the computerized equipment. The access controller authenticates a remote user after the transceiver has established a link with the remote user. If the user is authenticated as trusted and authorized for access, the access controller passes data from the remote user to the computerized equipment, and vice versa. Otherwise, all communications between the remote user and the computerized equipment are disabled. This embodiment of the invention is shown in FIG. 2. A telecommunications switch 100 having at least an access port 102 is accessed through the secure access controller 108 for systems maintenance purposes. The secure access controller 108 is further connected to the transceiver 110. The telecommunications switch 100 is serviced from the public switch telephone network 106 through the transceiver 110 and the secure access controller 108.

Each embodiment of the invention may operate as a stand-alone unit or to be controlled by a central administration authority which administers access to the computerized equipment.

FOG. 3 shows a schematic diagram representing a network configuration as it applies to maintenance of distributed telephone circuit switching equipment using access equipment according to a preferred embodiment of the invention. A command controllable computerized equipment, for example, a telecommunications switch 100 can be maintained and serviced through access ports 102. At least one secure access transceiver 104, from a secure access transceiver pool 122, is connected to one of the access ports 102 in order to provide secure and authenticated access to the telecommunications switch 100 for maintenance purposes. The secure access transceiver 104 has a data port (not shown) through which it connects to one of the access ports 102 of the telecommunications switch 100. The telecommunications switch 100 is serviced from a service point 114 located remotely with respect to the telecommunications switch 100.

In this example, a stand-alone user 116 using a portable computer 118 seeks access to the telecommunications switch 100. The stand-alone user 116 uses a secure service transceiver 120 to access the telecommunications switch 100. The secure service transceiver 120 has a data port (not shown) used to connect the secure service transceiver 120 to the portable computer 118. Associated with the user 166 is a smart card 122 which contains authentication information.

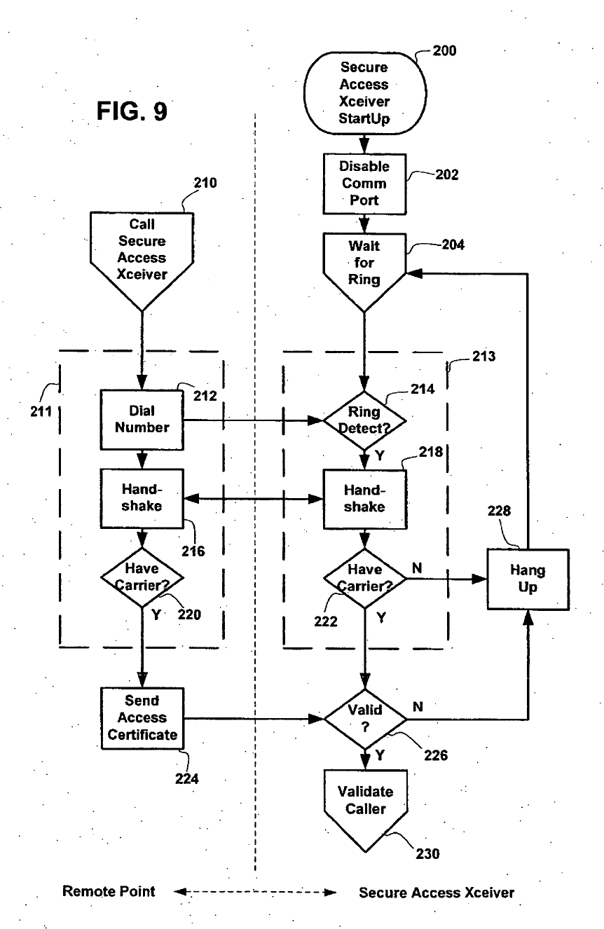

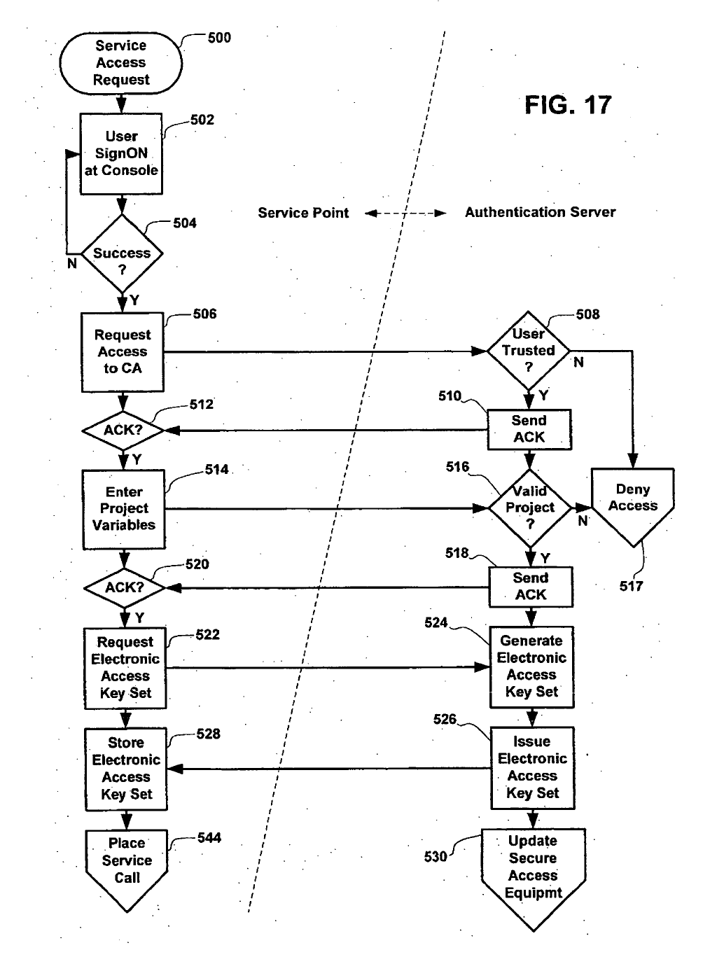

The access to the telecommunications switch 100 is managed by a service co-ordination center 124. To enforce control over secure access to the telecommunications switch 100, the service co-ordination center 124 has associated with it an authentication server 126. The authentication server controls access to selected equipment by permitting only authorized personnel to access the equipment, as will be described below with reference to FIG. 17. The stand-alone user 116 uses the secure service transceiver 120 to connect to the authentication server 126 of the service co-ordination center 124, shown as link A, through telecommunications switch 128, the public switched telephone network (PSTN) 106 and telecommunications switch 130. If the stand-alone user is successfully validated as an authorized person, the service co-ordination center 124 connects to the secure access transceiver 104, shown as link B, through telecommunications switch 130 and the PSTN 106 to update equipment memory to permit the stand-alone user to access the equipment as will be explained below in detail. In order for the user 116 to service the telecommunications switch 100, shown as link C, the user 116 uses the secure service transceiver 120 to connect through telecommunications switch 128, the PSTN 106, the telecommunications switch 100, the secure access transceiver 104 and the access ports 102 of the telecommunications switch 100. During the process of establishing a service link with the telecommunications switch 100, the stand-alone user 116 is validated as an authorized person in a process described below with reference to FIGS. 9 to 12.

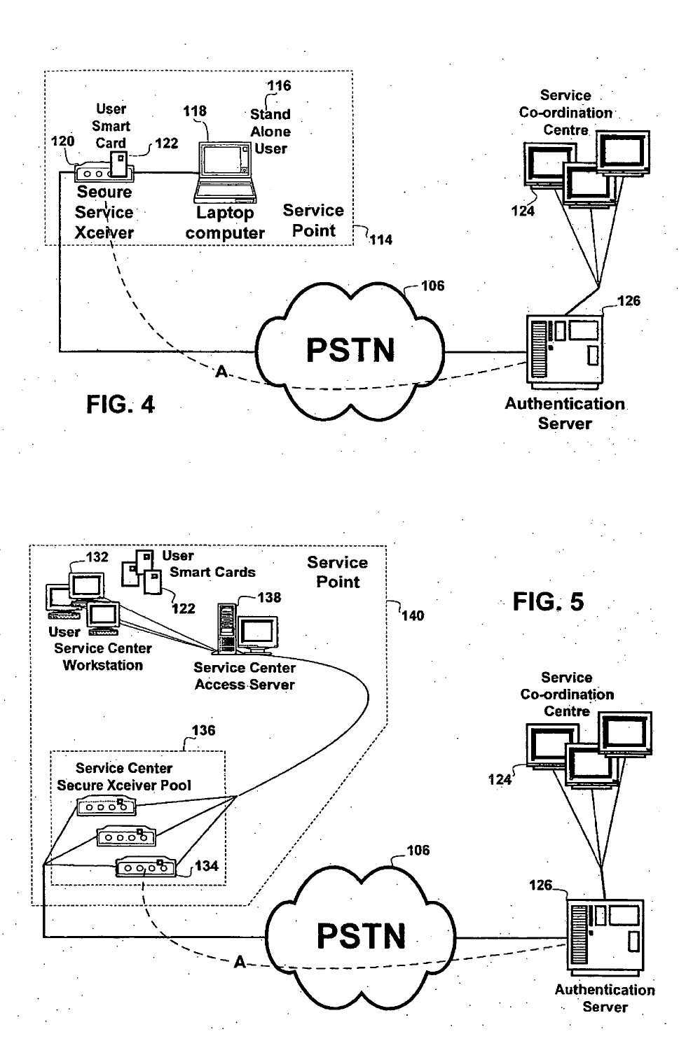

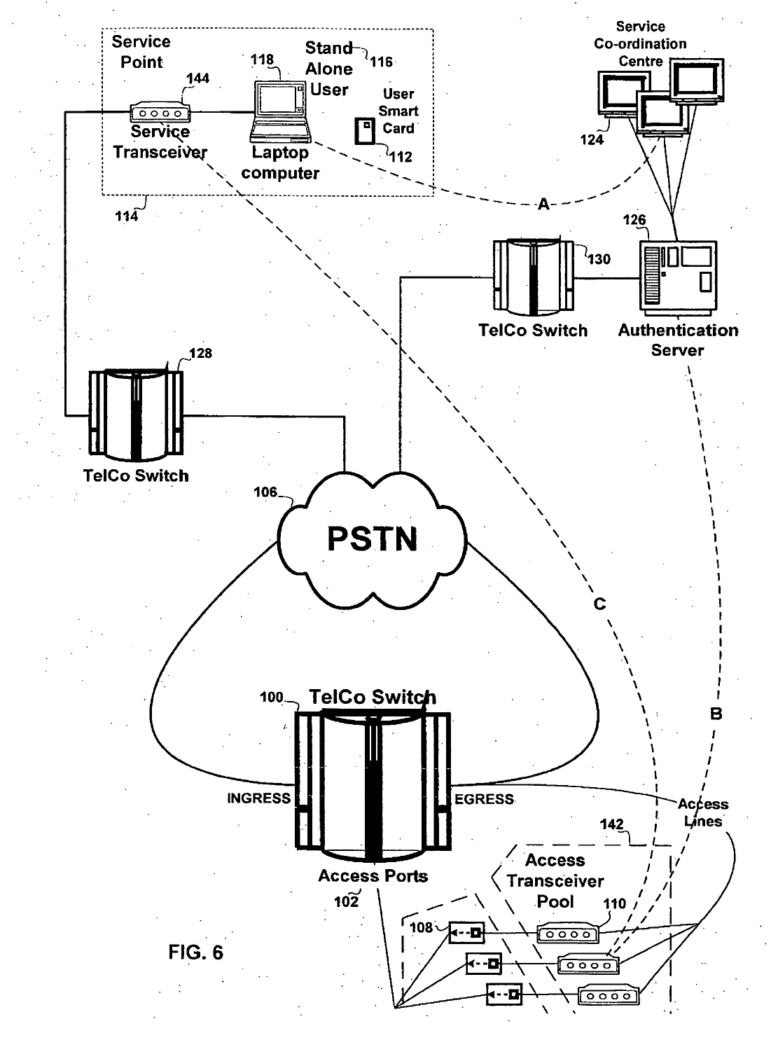

FIGS. 4 and 5 are schematic diagrams showing the relationship between service points 114, 140, as explained above, the stand-alone user 116 is equipped with the portable computer 118 and the secure service transceiver 120. The stand-alone user 116 accesses the co-ordination center 124 in order to request access to service command controllable computerized equipment through the public switched telecommunications network 106. FIG. 5 shows another service point from which users 132 work from service center workstations using secure service transceivers 134 which are components of a secure service transceiver pool 136.

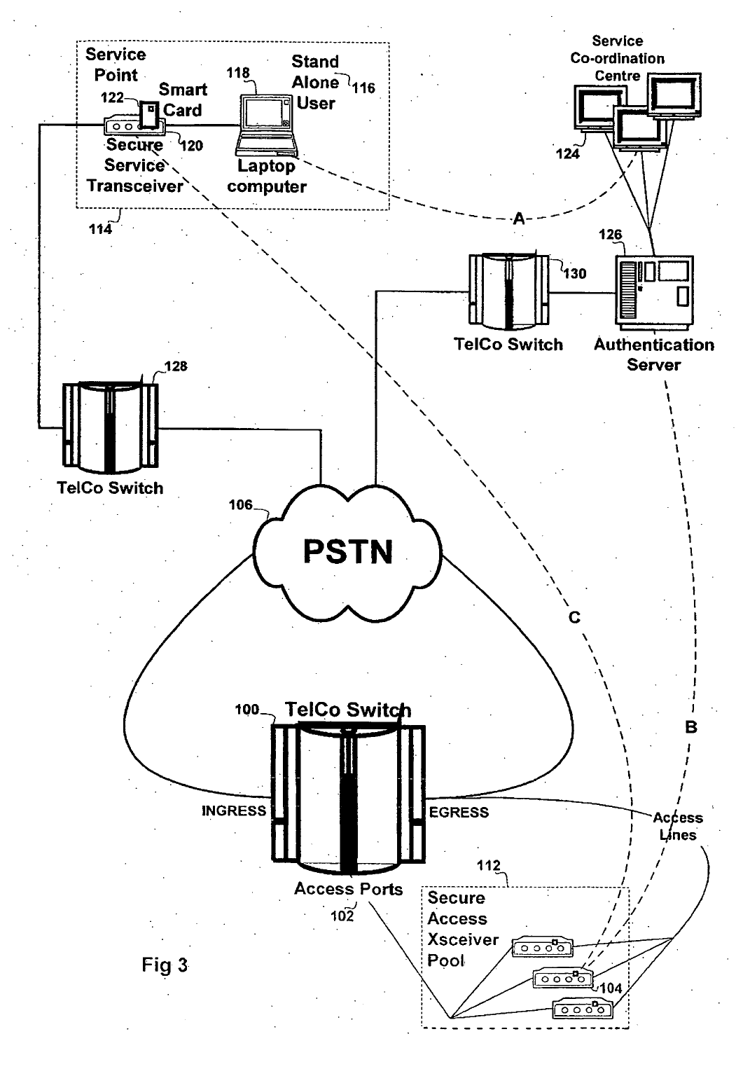

FIG. 6 is a connection diagram showing a network configured similarly to the network shown in FIG. 3 except that access to the telecommunications switch 100 is accomplished using standard transceivers and access is controlled by secure access controllers in accordance with the invention. The telecommunications switch 100 is serviced through access ports 102. At least one secure access controller 108, connected on a one-to-one basis with an access transceiver 110, provides secure authenticated access to the telecommunications switch 100 for purposes of maintaining and servicing the telecommunications switch 100. Access transceiver 110 may be a part of a pool of access transceivers 142. The access transceiver 110 has a data port (not shown) with which it connects to one of the secure access controllers 108. The secure access controller 108 has two data ports (not shown) through which it connects on one side to the access transceiver 110 and on the other side to an access port 102 of the telecommunications switch 100. The telecommunications switch 100 is serviced from a service point 114 located remotely with respect to the telecommunications switch 100.

Using the access equipment shown in FIG. 6, a stand-alone user 116, using a portable computer 118 services the telecommunications switch 100. In order for the stand-alone user 116 to access the telecommunications switch 100, a service transceiver 144 is employed. Preferably, the user 116, is issued a smart card 122 which contains authentication information, although other authentication schemes may be used for the same purpose. Network-centric control over access to the telecommunications switches to be services is provided by the service co-ordination center 124.

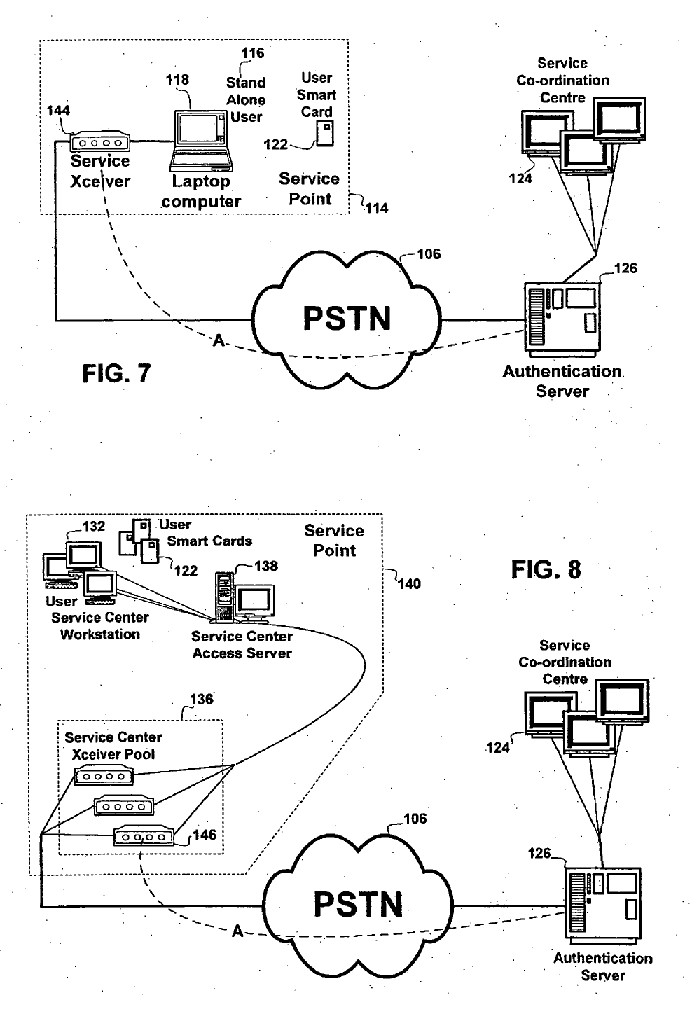

FIGS. 7 and 8 show two types of service points, one consisting of a stand-alone user with a portable computer and the other consisting of a user at a service center. The user equipment is distinguished from the user equipment described in FIGS. 4 and 5 because standard transceivers 144, 146 are used at the remote service points.

FIG. 9 shows a like-establishing sequence performed by the secure access transceivers in accordance with the invention as an attempt is made to access computerized equipment connected to the secure access transceiver.

Upon power-up, the secure access transceiver 104 (FIG. 3) performs a start-up sequence (step 200) during part of which the communications port of the secure access transceiver 104 connected to the command controllable computerized equipment is disabled (step 202). The start-up sequence terminates, leaving the secure access transceiver in a state in which the secure access transceiver 104 is waiting for a ring signal, step 204.

When a call is initiated in step 210, from a remote point, a dialing sequence is performed (step 212). The dialing sequence triggers a link establishing process 211. The detection of the ring signal, at the secure access transceiver 104, in step 214, initiates a corresponding link establishing process 213. Upon detection of the ring signal, the secure access transceiver 104 and the transceiver at the remote point begin a handshake sequence, steps 216 and 218. A successful handshake commencement of the sequence terminates in both ends detecting a carrier signal, steps 220 and 222, thereby terminating link establishing processes 211 and 213. After the carrier signal is established, the transceiver at the remote point sends authentication information to the secure access transceiver 104 (step 224). The secure access transceiver 104 validates the authentication information in step 226. Failure to detect the carrier signal in step 222 and/or failure to authenticate the remote user at the remote point, in step 226, causes the secure access transceiver 104 to hang up (step 228), and return to a state of waiting for a ring signal, step 204. If authentication of the information received by the secure access transceiver 104 is successful, step 226, the secure access transceiver 104 initiates a cross validation process which commences with a validation of the remote user, in step 230.

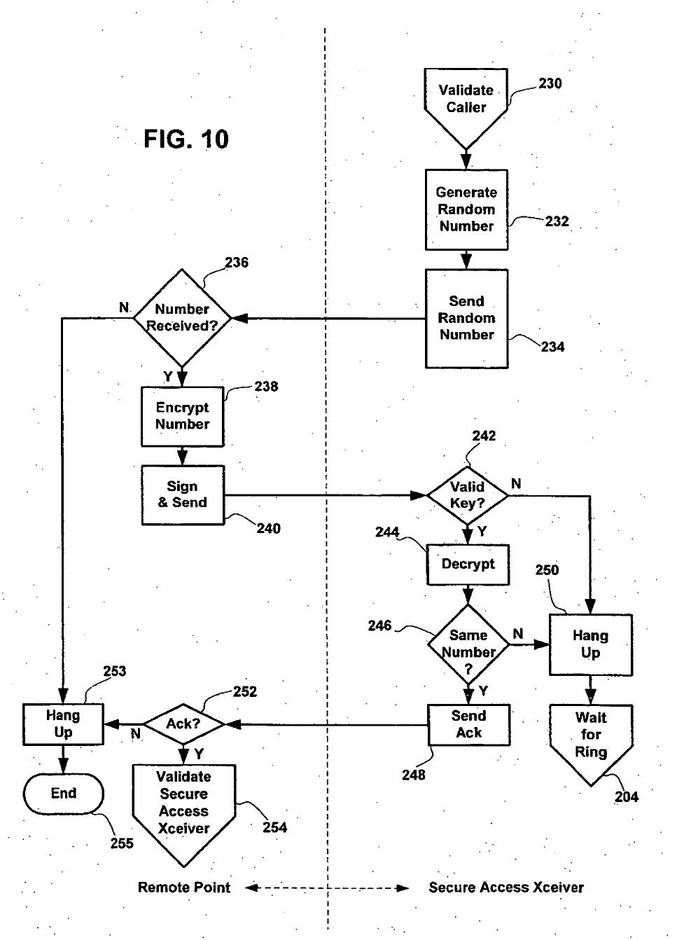

FIG. 10 is a flow diagram illustrating an exemplary process by which the secure access transceiver 104 validates the user. The user validation sequence starts when the secure access transceiver generates a random number in step 232. The random number is sent, in a message, to the remote point (step 234). Upon receipt of the message at the remote point, the number is encrypted using an electronic encryption key in step 238. The encrypted number is signed at the remote point with an electronic signature and the encrypted and signed number is sent back to the secure access transceiver 104 in another message (step 240). Upon receipt of this message, the secure access transceiver 104 validates the signature in step 242. If the signature belongs to an authorized user, the message is decrypted using a matching electronic decryption key, step 244. If the number sent by the secure access transceiver 104 matches the number received and decrypted by the secure access transceiver 104 (step 246), an acknowledgement is sent to the remote point (step 248). If the secure access transceiver 104 does not successfully validate the signature of the received message (step 242), or the decrypted number does not match the one sent, the secure access transceiver 104 hangs up (step 250) and returns to the state of waiting for a ring signal (step 204). Acknowledgement of the validation of the user (step 252), may optionally initiate a secure access transceiver validation sequence (step 254) for enhanced security. The remote point allows for a reasonable length of time to pass for the receipt of the message in step 236 and for the receipt of the acknowledgement in step 252. After a sufficient amount of time has elapsed for either of the two events, the remote point hangs up in step 253 and terminates in step 255.

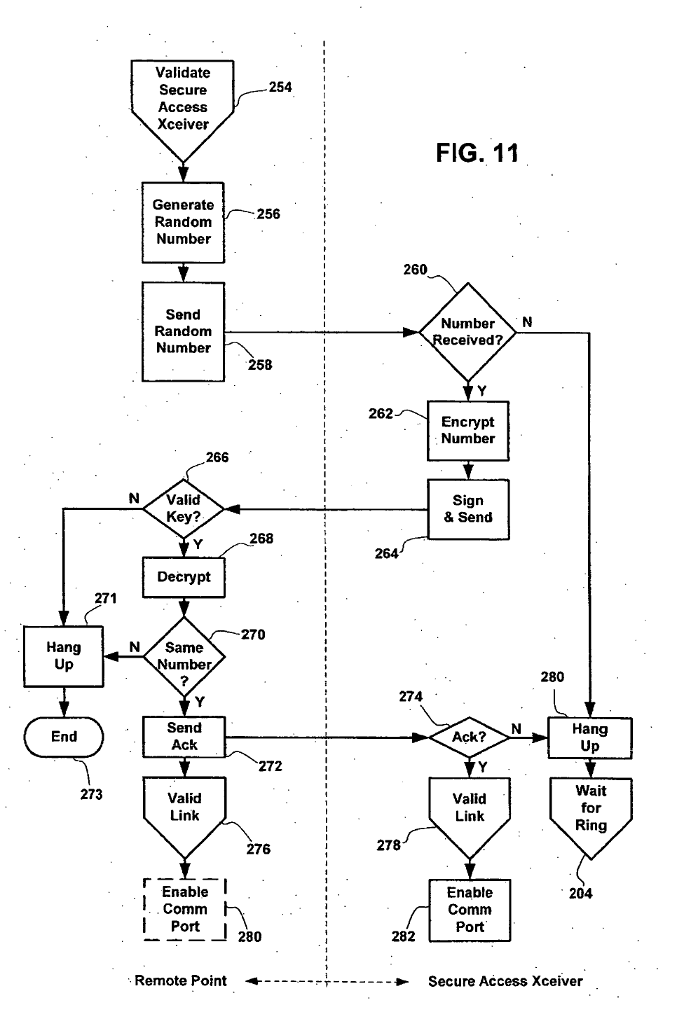

FIG. 11 shows the secure access transceiver validation process used for enhanced security. In order to validate the secure access transceiver 104, a random number is generated at the remote point in step 256. The random number is sent to the secure access transceiver 104 in a message, in step 258. An encryption of the number using another electronic encryption key is performed in step 262. The encrypted number is signed by the secure access transceiver 104 using another electronic signature and the encrypted and signed number is sent to the remote point in a message in step 264. The remote point allows for a reasonable length of time to pass for the receipt of the encrypted and signed message in step 266. After a sufficient amount of time has elapsed the remote point hangs up in step 271, and terminates in step 273. Validation of the secure access transceiver signature is performed in step 266. Upon successful validation of the secure access transceiver's signature key, the message is decrypted using another electronic decryption key in step 268. A comparison is performed between the generated random number and the received number in step 270. Upon successful comparison of the two numbers, an acknowledgement message is sent to the secure access transceiver in step 272. The remote point also hangs up, in step 271, if the comparison of the two numbers is unsuccessful. If the secure access transceiver fails to receive a message from the remote point, in step 260, or if the remote point does not send an acknowledgement message, in step 274, the secure access transceiver 104 hangs up, in step 280, and returns to a state in which it is waiting for a ring signal, step 204. Successful cross-validation leads to establishing a valid link (steps 278 and 276). Upon validating the link, the secure access transceiver 104 enables the communication port connected to the command controllable computerized equipment, in step 282. At the same time, the remote point may also enable its communication port, if it had been previously disabled.

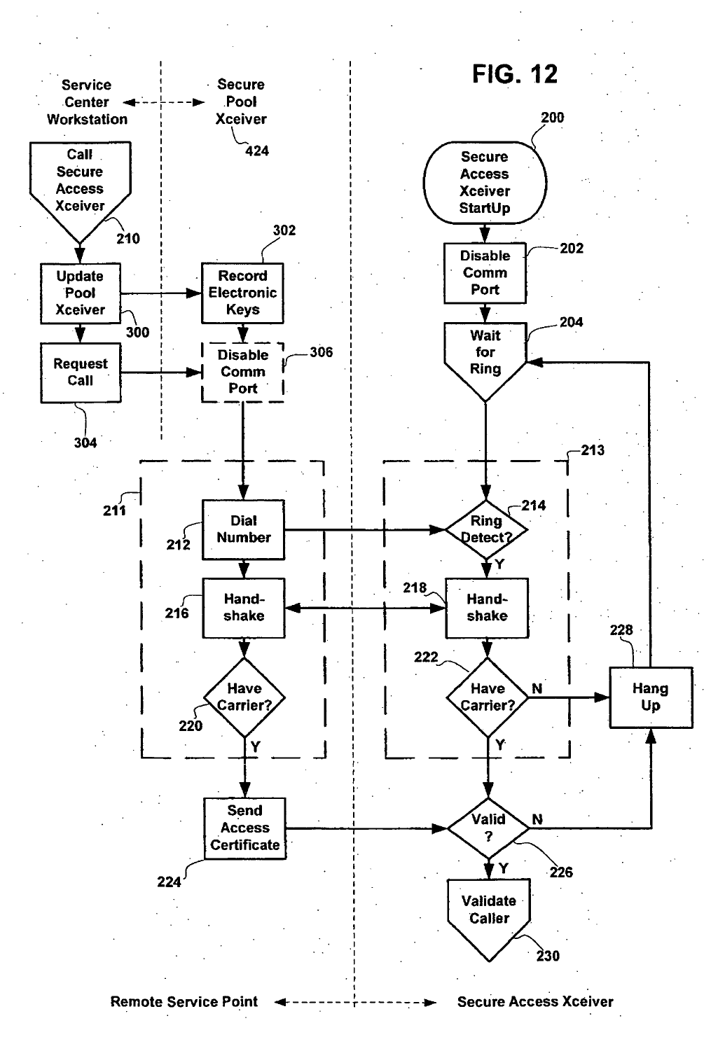

Shown in FIG. 12 are the details of the initiation of a service call by a user 132 from a workstation associated with a pool 136 of secure service transceivers 146. The procedure is similar to the one shown in FIG. 9 except for a few preliminary steps. On placing the service call from the workstation, the first step is to update, in step 300, a secure service transceiver 134, assigned by a service center access server 138 to the workstation from the pool 136, with electronic keys necessary for the authentication and validation steps. The secure service transceiver 134 in the pool 136 records the necessary electronic keys in step 302. A call request is placed at the service workstation, in step 304, in response to which the secure service transceiver 134 in the pool 136 may disable its communications port, step 306, and proceeds with the call and authentication process as previously described in relation to FIG. 9.

The above described implementation is suitable for deployment of new services to be offered. For the case in which the command controllable computerized equipment with the associated access transceiver are already deployed, replacement of existing access transceivers with secure access transceivers would not be a financially viable solution. This is the reason behind the second embodiment in which in which secure access controllers are installed between the access transceivers and the command controllable computerized equipment are already deployed.

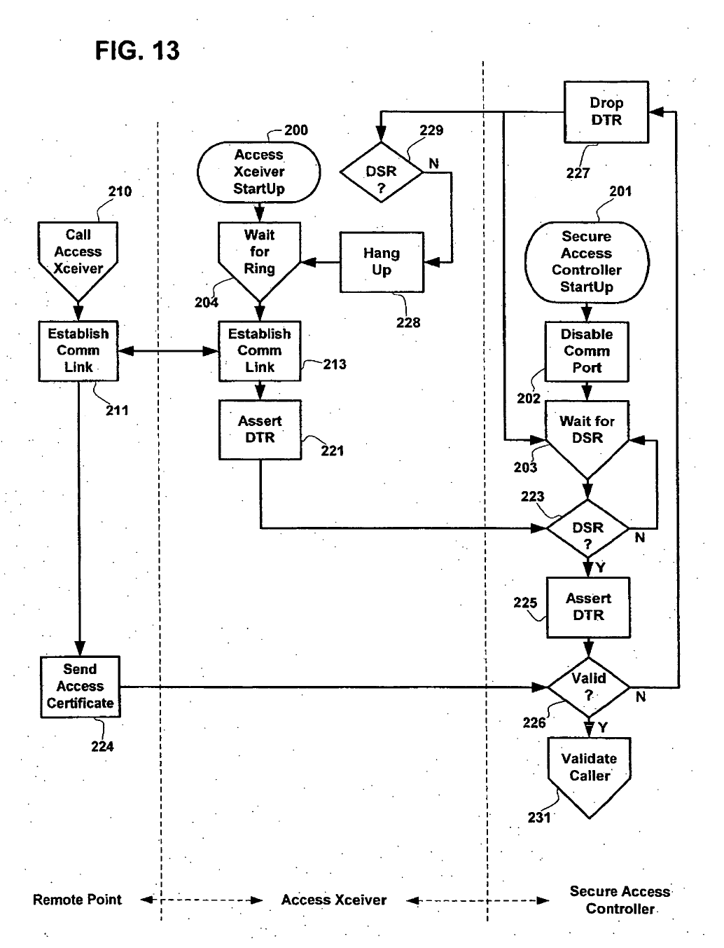

Accordingly, a method of authenticating an entity seeking access from a remote point to command controllable computerized equipment through an access transceiver and a secure access controller is shown in FIG. 13. Upon power-up, the access transceiver goes through a start-up sequence, step 200. The start-up sequence terminates, leaving the access transceiver in a state in which the access transceiver is waiting for a ring signal, step 204.

On placing a call to the access transceiver, step 210 from a remote point, the remote point and the access transceiver go through a process of establishing a communications link, steps 211 and 213, respectively. Upon establishing a communications link, the access transceiver informs the secure access controller of the established communication link by asserting a Data Terminal Ready signal (DTR), step 221.

Upon power-up of the secure access controller 108 (step 201), the secure access controller 108 disables its communication port connected to the computerized equipment (step 202). The start-up sequence of the secure access controller 108 terminates leaving the secure access controller 108 in a state in which it is waiting for a Data Set Ready (DSR) signal (step 203). Upon detection of the DSR signal, by the secure access controller, in step 203, which is equivalent to detecting the assertion of the DTR set by the access transceiver, the secure access controller 108 asserts its DTR signal in step 225, establishing a link between the access transceiver 110 and the secure access controller 108. Upon establishing the communications link, in step 211, the remote point sends an access certificate, in step 224, to the secure access controller 108. In step 226, the secure access controller 108 validates the access certificate and, upon validation of the access certificate, the secure access controller 108 initiates a cross validation sequence starting by validating the caller (step 231). Failing to validate the access certificate in step 226, the secure access controller 108 drops its DTR signal in step 227. The access transceiver 110 monitors its DSR input and, if the secure access controller 108 drops its DTR signal, the access transceiver 110, in step 228, hangs up and returns to a state in which it is waiting for a ring (step 204). At the same time, the secure access controller returns to a state in which it is waiting for a DSR signal.

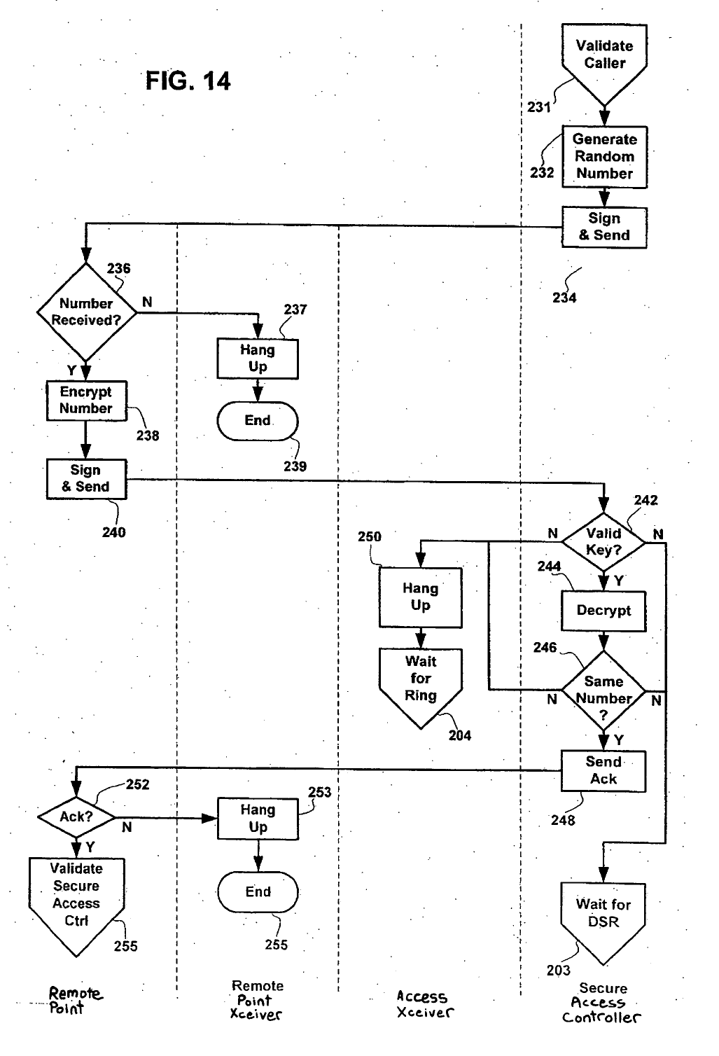

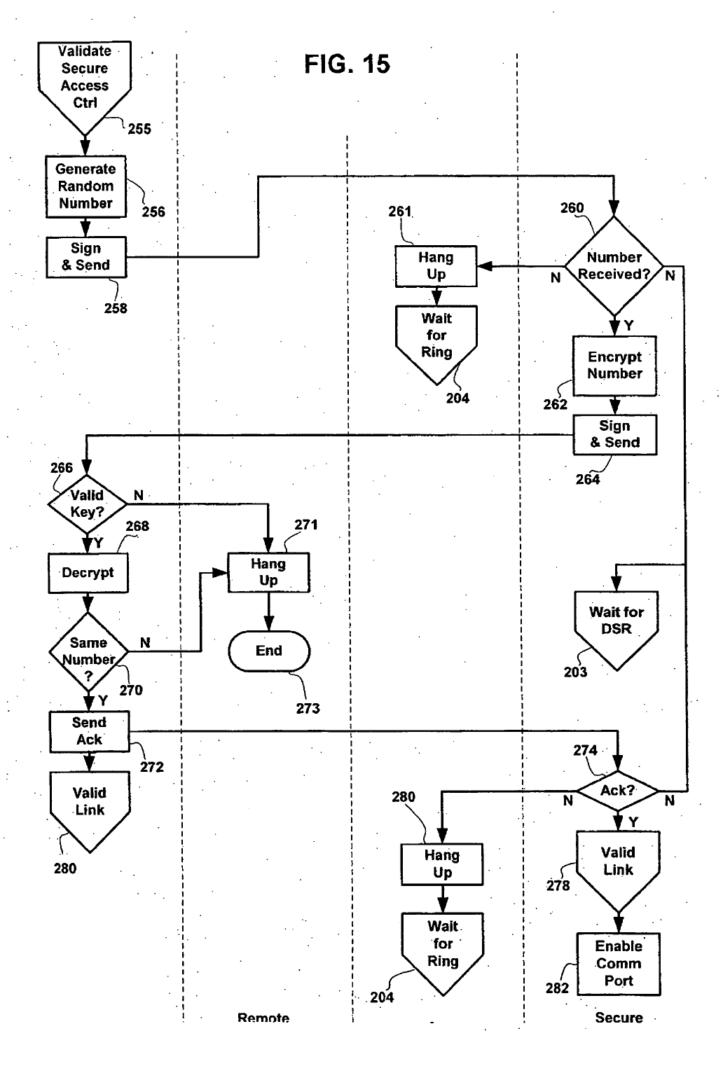

FIGS. 14 and 15 show the details of the cross validation sequence between the remote point in the secure access controller 108. The steps of the cross-validation sequence are similar to the sequence presented above in relation to the preferred embodiment with the distinction that authentication is handled by the remote point and the secure access controller, and the details of establishing the connection are handled by the transceiver at the remote point and the access transceiver, respectively.

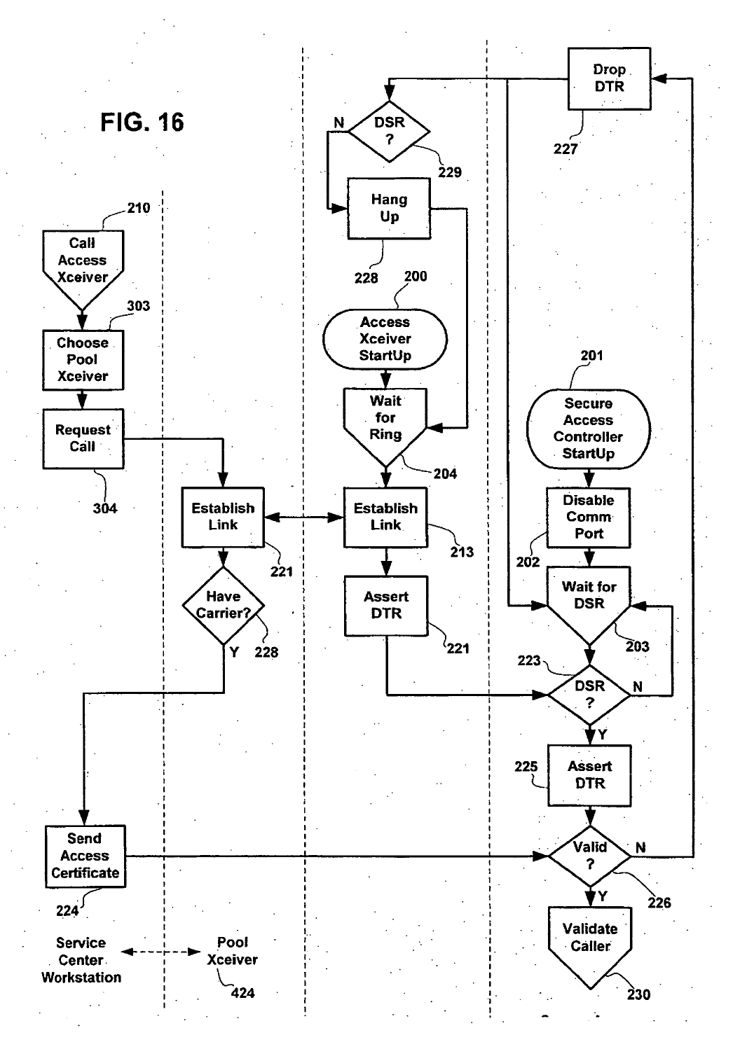

FIG. 16 shows the extra details related to placing a service call from a service center workstation. A transceiver 146 from the transceiver pool 136 is selected and remains associated with the service call for the duration of the service session.

All other details are similar to the previous implementation in all respects. In fact, the two implementations presented can co-exist and inter-operate with each other.

Having described the implementation details according to two examples; the secure access transceiver and the secure access controller will be henceforth referred to as secure access equipment.

A preferred implementation of a method for enforcing network-centric control over access to command controllable computerized equipment is shown in FIGS. 17, 18, 19 and 20. FIG. 17 in particular shows the details of a process by which a service access request is initiated. A user who is a member of an authorized community to access telecommunications switches is assigned a project. The user proceeds from a service access request, step 500. The user 116 signs on at a console, such as a portable computer 118 for example, in step 502. Upon successful sign-on, the user requests access to the authentication server 126 by entering relevant information about the user, step 506. The authentication server 126 checks as to whether the user is still a trusted user, step 508. If the user is still a trusted user, the authentication server 126 sends an acknowledgement message to the service point, step 510. On receiving the acknowledgement message, in step 512, the user enters project variables, in step 514. The authentication server 126 checks as to whether the project is a valid project and whether the user is expected to service the telecommunications switch 100 specified by the project, as previously defined in a database at the authentication server, step 516. If the project is valid, the authentication server sends an acknowledge message, in step 518, to the service point. Failing to recognize the user as a trusted user in step 508 or failing to find a previously defined valid project in the database associated with the user in step 516, the authentication server 126 denies access to the user in step 517. On receiving acknowledgement in step 520, the user requests an electronic access key set, in step 522. The authentication server 126 generates an electronic key set, step 524, and sends the key set to the user, in step 526. The user stores the electronic access key set which is valid for a duration of the service to be performed, or a limited time period thereof.

Following this initiation process, the authentication server 126 proceeds to update the secure access transceiver 104 connected to the telecommunications switch 100 specified by the project, in step 530. Having the electronic access key set, the user proceeds to place a service call to the secure access transceiver 104 and service the telecommunications switch 100 as specified by the project, step 544.

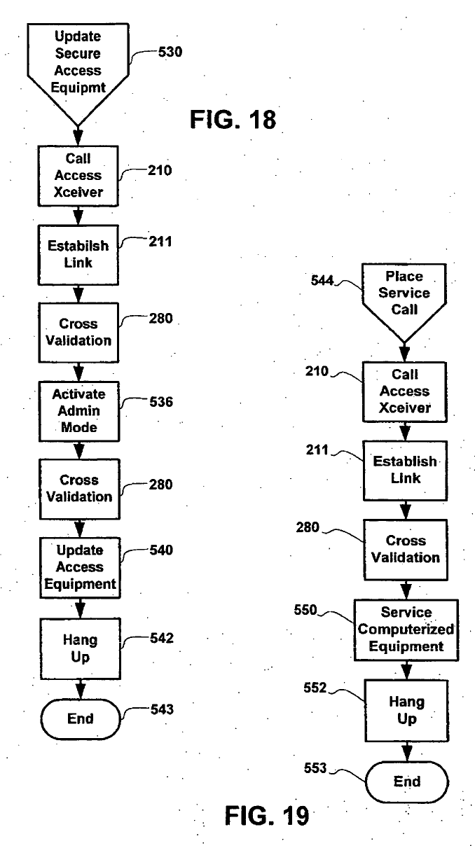

The update process of the secure access transceiver 104 is shown in FIG. 18. The necessary steps involved are: calling, 210, the secure access transceiver 104, step 210; establishing a link, step 211; performing cross validation, step 280, activating administration mode, step 536; cross validating at the administration level, step 280; updating the secure access transceiver, step 540 and ending, step 543, by hanging up, step 542.

The process followed in the course of a service session is shown in FIG. 19. In servicing the telecommunications switch 100 connected to a secure access transceiver 104 specified by the project, a user follows the following steps: a call is placed to the secure access transceiver 104, step 210; a link is established, step 211; cross validation is performed, step 280, a service session follows in which the telecommunications switch 100 is serviced, step 550, and on completion, the session is terminated, 553, by a hang-up in step 552.

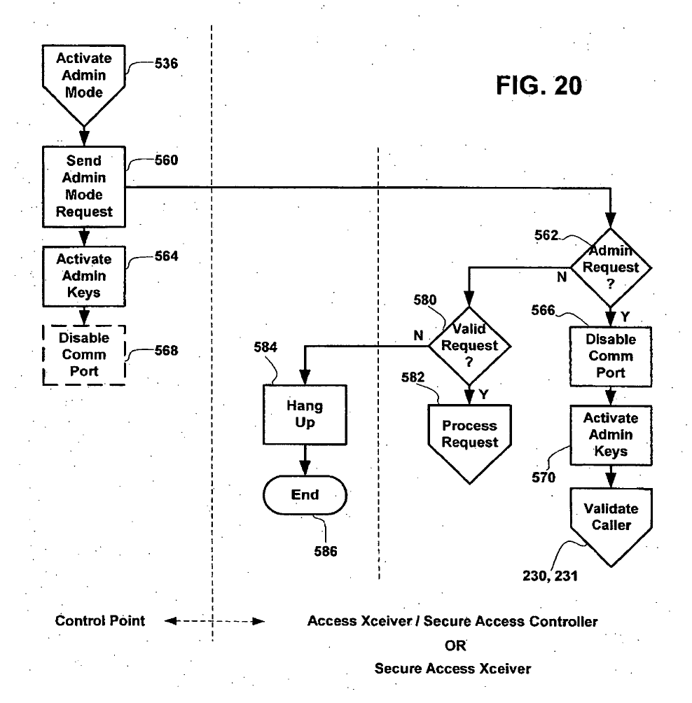

The process by which a control transceiver and secure access equipment activate the administration mode is shown in FIG. 20. On activating administration mode 536, the control transceiver associated with the authentication server 126 sends an administration mode request in step 560. The control transceiver also activates its electronic administration keys and may disable its communication port (steps 564 and 568, respectively). On receiving an administration mode request in step 562, the secure access equipment disables the communication port, activates its electronic administration keys and proceeds to validate the caller as part of the cross validation process (steps 566, 570 and 230, respectively). If the request received in step 562 is not an administration mode request, the secure access equipment checks as to whether the request is a valid request in step 580. If the request is valid, then the secure access equipment proceeds to process the request. If the request is not valid then the secure access equipment hangs up in step 584 terminating the session, step 586.

In order to implement network-centric control over access to deployed command controllable computerized equipment accessed through secure access equipment, functionality is provided on the secure access equipment to enable it to act independently of the co-ordination center. The secure access equipment is provided with electronic memory storage, embedded processing capabilities, absolute time clock, etc. The electronic memory storage is used to store, in a retrievable fashion, authentication information, transaction records and certificate revocation lists.

Active certificates corresponding to ongoing service projects are stored in the authentication information portion of the memory storage. The access certificates include the electronic access keys, as mentioned in the above descriptions. These access certificates have a time period of validity which is enforced using the real time clock. Records regarding access to the command controllable computerized equipment through the secure access equipment are kept in the transaction records portion of the memory storage. Invalid certificates are stored in the certificate revocation list portion of the memory storage.

Upon updating the secure access equipment from a control point: new access certificates are stored in the authentication information portion of the memory storage, the transaction records are downloaded and the revocation lists updated. Alternatively the secure access equipment can call the control point to download its transaction records and update its revocation lists either on a specific time cycle or on critical conditions triggered by lengthy transaction records and stale revocation lists. Other situations related to enforcing secure access to command controllable computerized equipment in which the secure access equipment can call the control point would include numerous repetitive failed access attempts from the same remote point.

Having the elements mentioned above different methods known in the art providing different degrees of secure access can be implemented in an actual realisation but still falling within the scope of the invention. For example, as an added level of security, once the service session is established, an encryption key can be generated and used for encrypting the exchanged data over the communications link for the duration of the service session. This encryption key would only be known to the secure access equipment and the service point. Another implementation would have the electronic memory storage, the real time clock and the embedded processor on a smart card associated with the secure access equipment.

Although the invention has been explained with reference to telephone network equipment, it should be understood by those skilled in the art that the invention is in no way limited to such applications. The apparatus and methods in accordance with the invention may be used to control access to any computerized equipment accessed by a transceiver. For example, the invention may be used to control access to a personal computer, local or wide area network, any other computing machine or computerized equipment having an access port that may be accessed through a transceiver.

The scope of the invention is therefore intended to be limited solely by the scope of the appended claims.

We claim:

1-60. (canceled)

61. A system for controlling access to computerized equipment by a remote entity, said system comprising:
an authentication server and an access controller interconnectable with each other and with said remote entity for communications therebetween, said access controller connected to said computerized equipment;
said authentication server operable to provide said remote entity with a first access key and said access controller with a second access key corresponding to said first access key;
said access controller operable to attempt to authenticate said remote entity at least in part on a basis of said access keys, wherein said access controller enables data to pass from said remote entity to said computerized equipment only upon successful authentication of said remote entity.

62. A system as defined in claim 61, wherein said authentication server is operable to generate said first and second access keys.

63. A system as defined in claim 61, wherein said access controller and said remote entity are interconnectable over a first communications link and said authentication server and said remote entity are interconnectable over a second communications link, each of said communications links being established via a network.

64. A system as defined in claim 63, wherein said network is the PSTN.

65. A system as defined in claim 61, wherein said computerized equipment is a telecommunications switch.

66. A system as defined in claim 61, wherein said authentication server is responsive to a request from said remote entity for access to said computerized equipment to provide said remote entity and said access controller with said access keys.

67. A system as defined in claim 61, wherein said authentication of said remote entity performed by said access controller includes a validation process utilizing said keys.

68. A system as defined in claim 67, wherein said validation process includes a generation of a random number by said access controller, a delivery of said random number to said remote entity, an encryption of said random number by said remote entity using said first access key, a delivery of said encrypted random number from said remote entity to said access controller, a decryption of said encrypted number using said second access key by said access controller, and a comparison of said random number and said decrypted number to validate that said remote entity is authorized to access said computerized equipment.

69. A system as defined in claim 68, wherein if a match is found between said random number and said decrypted number, said access controller enables data to pass from said remote entity to said computerized equipment.

70. A system as defined in claim 68, wherein if no match is found between said random number and said decrypted number, said access controller prevents data from passing from said remote entity to said computerized equipment.

71. A system as defined in claim 68, wherein said remote entity provides said encrypted random number with a digital signature before sending said encrypted random number to said access controller, said access controller operable to verify said digital signature to ensure that said remote entity is authorized to access said computerized equipment before decrypting said encrypted random number.

72. A system as defined in claim 61, wherein said authentication server only provides said first access key to said remote entity if a user operating said remote entity authenticates said user's identity with said authentication server.

73. A system as defined in claim 61, wherein said first and second access keys are valid for only one access session to said computerized equipment.

74. A system as defined in claim 61, wherein said first and second access keys are valid for a predetermined period of time.

75. A system as defined in claim 61, wherein said first and second access keys are valid for a duration of a service to be performed on said computerized equipment.

76. A method for controlling access to computerized equipment by a remote entity, the computerized equipment connected to an access controller operative to enable data to be passed from the remote entity to the computerized equipment if the remote entity is successfully authenticated, said method comprising:
receiving a request for access to the computerized equipment from the remote entity;
determining a first access key and a second access key corresponding to said first access key;
providing said first access key to the remote entity;
providing said second access key to the access controller for use in the authentication of the remote entity.

77. A method as defined in claim 76, wherein the step of determining said first and second access keys includes generating said first and second access keys.

78. A method as defined in claim 76, wherein authentication of the remote entity by the access controller includes a validation process utilizing said keys.

79. A method as defined in claim 78, wherein said validation process includes a generation of a random number by the access controller, a delivery of said random number to the remote entity, an encryption of said random number by the remote entity using said first access key, a delivery of said encrypted random number from the remote entity to the access controller, a decryption of said encrypted number using said second access key by the access controller, and a comparison of said random number and said decrypted number to validate that the remote entity is authorized to access the computerized equipment.

80. A method as defined in claim 76, further comprising the steps of identifying a user operating the remote entity and authenticating the identity of the user prior to providing said first access key to the remote entity.

81. A method as defined in claim 76, wherein said first and second access keys are valid for only one access session to the computerized equipment.

82. A method as defined in claim 76, wherein said first and second access keys are valid for a predetermined period of time.

83. A method as defined in claim 76, wherein said first and second access keys are valid for a duration of a service to be performed on the computerized equipment.

84. An authentication server for controlling access to computerized equipment by a remote entity, said computerized equipment connected to an access controller, said authentication server responsive to a request from said remote entity for access to said computerized equipment to provide said remote entity with a first access key and said access controller with a second access key corresponding to said first access key, wherein said first access key is usable by said remote entity for communication with said access controller and said second access key is usable by said access controller for attempting to authenticate said remote entity, said access controller enabling data to be passed from said remote entity to said computerized equipment only upon successful authentication of said remote entity.

85. In an authentication server, a method of controlling access to computerized equipment by a remote entity, said computerized equipment connected to an access controller operative to enable data to be passed from said remote entity to said computerized equipment if said remote entity is successfully authenticated, said method comprising:
receiving a request from said remote entity for access to said computerized equipment;
delivering a first access key to said remote entity, said first access key usable by said remote entity for communication with said access controller;
delivering a second access key to said access controller for use in the authentication of said remote entity.

86. A method as defined in claim 85, further comprising the step of generating said first and second access keys in response to said request from said remote entity for access to said computerized equipment.

87. A method as defined in claim 85, wherein the step of delivering a second access key to said access controller includes:
establishing a communications session with said access controller;
validating to said access controller that said authentication server is a trusted administrator;
commencing an administration session with said access controller; and
transmitting said second access key to said access controller for storage in a memory of said access controller.

88. A method as defined in claim 85, further comprising the step of providing updated authentication information to said access controller for use in authenticating said remote entity.

89. A method as defined in claim 88, wherein said updated authentication information includes one or more access certificates.

90. A method as defined in claim 89, wherein said one or more access certificates include one or more electronic access keys.

91. A method as defined in claim 88, wherein said updated authentication information includes an updated second access key.

92. A method as defined in claim 88, wherein said updated authentication information includes one or more lists of revoked electronic access keys.

93. An access controller for intermediating communications between a remote entity and computerized equipment, said remote entity using a first access key for communicating with said access controller, said access controller operative to use a second access key complementary to said first access key for attempting to authenticate said remote entity, said access controller enabling data to be passed from said remote entity to said computerized equipment only upon successful authentication of said remote entity.

94. An access controller as defined in claim 93, wherein said authentication of said remote entity by said access controller includes a validation process utilizing said access keys.

95. An access controller as defined in claim 94, wherein said validation process includes a generation of a random number by said access controller, a delivery of said random number to said remote entity, an encryption of said random number by said remote entity using said first access key, a delivery of said encrypted random number from said remote entity to said access controller, a decryption of said encrypted number using said second access key by said access controller, and a comparison of said random number and said decrypted number to validate that said remote entity is authorized to access said computerized equipment.

96. In an access controller, a method for selectively passing data from a remote entity to computerized equipment in order to ensure secure access to the computerized equipment, said remote entity using a first access key for communicating with said access controller, said method comprising:
using a second access key complementary to said first access key for attempting to authenticate said remote entity;
if authentication of said remote entity is successful, enabling data to be passed from said remote entity to said computerized equipment;
if authentication of said remote entity fails, preventing data from being passed from said remote entity to said computerized equipment.

97. A method as defined in claim 96, wherein attempting to authenticate said remote entity includes implementing a validation process utilizing said access keys.

98. A method as defined in claim 97, wherein said validation process includes a generation of a random number by said access controller, a delivery of said random number to said remote entity, an encryption of said random number by said remote entity using said first access key, a delivery of said encrypted random number from said remote entity to said access controller, a decryption of said encrypted number using said second access key by said access controller, and a comparison of said random number and said decrypted number to validate that said remote entity is authorized to access said computerized equipment.

99. A method as defined in claim 96, further comprising the step of receiving said second access key from an authentication server, said authentication server operable to initiate communications sessions with said remote entity and said access controller in order to provide said remote entity and said access controller with said first and second access keys respectively.

100. A method as defined in claim 99, further comprising the step of validating that said authentication server is a trusted administrator.

101. A method as defined in claim 100, wherein the step of validating said authentication server includes:
generating a segment of data and sending the segment of data to said authentication server;
receiving the segment of data returned from said authentication server in an encrypted form and decrypting the encrypted segment of data using said second access key; and
comparing the decrypted segment of data to a copy of the segment of data, and dropping the communications session if the segments of data do not match.

102. A method as defined in claim 99, wherein said access controller receives updated authentication information from said authentication server for use in authenticating said remote entity.

103. A method as defined in claim 102, wherein said updated authentication information includes one or more access certificates.

104. A method as defined in claim 103, wherein said one or more access certificates include one or more electronic access keys.

105. A method as defined in claim 102, wherein said updated authentication information includes an updated second access key.

106. A method as defined in claim 102, wherein said updated authentication information includes one or more lists of revoked electronic access keys.
